(19) United States
(12) Patent Application Publication
(10) Pub. No.: US 2016/0117089 A1
(43) Pub. Date: Apr. 28, 2016

(54) ELECTRONIC DEVICE AND METHOD FOR MANAGING DESKTOP SHORTCUTS

(71) Applicant: Chiun Mai Communication Systems, Inc., New Taipei (TW)

(72) Inventor: JIUN-RU HOU, New Taipei (TW)

(21) Appl. No.: 14/688,395

(22) Filed: Apr. 16, 2015

(30) Foreign Application Priority Data
Oct. 22, 2014 (CN) 201410568188.X

(51) Int. Cl. G06F 3/0484; G06F 17/30

(52) U.S. Cl. CPC G06F 3/04847; G06F 17/30598

(57) ABSTRACT

A method for managing desktop shortcuts of an electronic device includes setting a master shortcut for each of groups and a classification rule of the groups. According to the master shortcut in each of the groups and the classification rule of the groups, shortcuts on a desktop of the electronic device are classified into the groups. Each of the groups is displayed using a graphics on a display device of the electronic device.

### CROSS-REFERENCE TO RELATED APPLICATIONS

This application claims priority to Chinese Patent Application No. 201410568188.X filed on Oct. 22, 2014, the contents of which are incorporated by reference herein.

### FIELD

Embodiments of the present disclosure relate to desktop management technology, and particularly to managing desktop shortcuts of an electronic device.

### BACKGROUND

Shortcuts of applications on a desktop of an electronic device are separately displayed. A user cannot directly see correlations of the shortcuts of applications. For example, when the user desires to find similar applications, the user has to look through all the shortcuts on the desktop.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a management system.

FIG. 2 is a block diagram of one embodiment of function modules of the management system in the electronic device of FIG. 1.

FIG. 3 illustrates a flowchart of one embodiment of a method for managing desktop shortcuts in the electronic device of FIG. 1.

FIG. 4 is a diagrammatic view of a honeycomb pattern.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

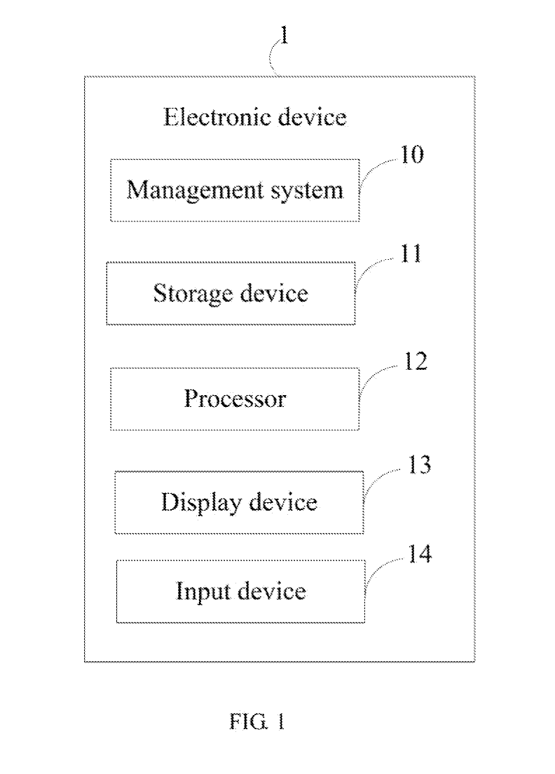

FIG. 1 illustrates a block diagram of one embodiment of an electronic device. In at least one embodiment as shown in FIG. 1, an electronic device 1 includes, but is not limited to, a management system 10, a storage device 11, at least one processor 12, a display device 13, and an input device 14. The electronic device 1 can be a tablet computer, a notebook computer, a smart phone, a personal digital assistant (PDA), or another suitable electronic device. FIG. 1 illustrates only one example of the electronic device that can include more or fewer components than illustrated, or have a different configuration of the various components in other embodiments.

The management system 10 can classify shortcuts on a desktop of the electronic device 1 into a plurality of groups according to correlations of applications corresponding to the shortcuts. A user of the electronic device 1 can see correlated applications via shortcuts in a same group.

In at least one embodiment, the storage device 11 can include various types of non-transitory computer-readable storage mediums. For example, the storage device 11 can be an internal storage system, such as a flash memory, a random access memory (RAM) for temporary storage of information, and/or a read-only memory (ROM) for permanent storage of information. The storage device 11 can also be an external storage system, such as a hard disk, a storage card, or a data storage medium. The at least one processor 12 can be a central processing unit (CPU), a microprocessor, or other data processor chip that performs functions of the management system 10 in the electronic device 1. The display device 13 can display images and videos, and the input device 14 can be a mouse, a keyboard, or a touch panel.

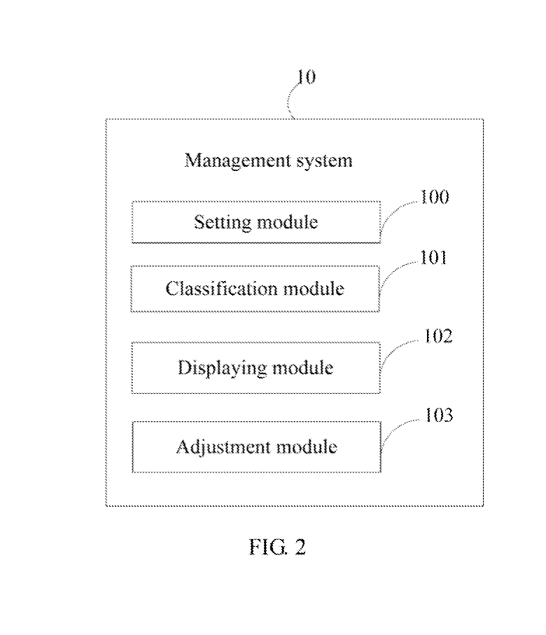

FIG. 2 is a diagrammatic view of one embodiment of function modules of the management system. In at least one embodiment, the management system 10 can include a setting module 100, a classification module 101, a displaying module 102, and an adjustment module 103. The function modules 100, 101, 102 and 103 can include computerized codes in the form of one or more programs, which are stored in the storage device 11. The at least one processor 12 executes the computerized codes to provide functions of the function modules 100-103.

The setting module 100 sets a plurality of groups, and sets a master shortcut for each of the groups and a classification rule of the groups. In at least one embodiment, the setting module 100 provides a user interface (UI) on the display device 13 for the user to select the master shortcut for each of the groups and set the classification rule of the groups. According to selections and settings of the user, the setting module 100 sets the master shortcut for each of the groups and the classification rule of the groups. The setting module 100 can further provide an option of selecting or setting a number of the groups and an option of selecting or setting a number of shortcuts in each of the groups on the user interface for the user.

In at least one embodiment, each of the shortcuts in each of the groups corresponds to an application, and the master shortcut in each of the groups corresponds to a master application. The classification rule represents a relationship between the master shortcut in each of the groups and other shortcuts in each of the groups. The classification rule includes two requirements, a first requirement requires that applications corresponding to other shortcuts in each of the groups are in a same application type with the master application in each of the groups, and a second requirement requires that shortcuts in each of the groups are determined according to invoking times of an application corresponding to each of the shortcuts in each of the groups. The invoking times represents times that an application is invoked by a master application of a group that the application belongs to within a first preset duration. In some embodiments, one of the two requirements of the classification rule is required while classifying the shortcuts on the desktops. In other embodiments, both of the two requirements of the classification rule are required while classifying the shortcuts on the desktop.

The classification module 101 classifies the shortcuts on the desktop of the electronic device 1 into the groups according to the master shortcut of each of the groups and the classification rule of the groups. Each of the groups includes a master shortcut and non-master shortcuts. The non-master shortcuts in each of the groups represent shortcuts in each of the groups except the master shortcut. The classification module 101 can classify one shortcut on the desktop into one or more groups. The classification module 101 can classify one master shortcut into another group according to a master shortcut of the another group and the classification rule. In other words, a master shortcut of a group can be a non-master shortcut in another group.

In at least one embodiment, for each of the groups, the classification rule of the groups requires that the other applications corresponding to the other shortcuts in each of the groups are in a same application type with the master application of each of the groups. For example, in one group, a preset number of shortcuts in the group is M. The classification module 101 determines specified shortcuts from the shortcuts on the desktop according to the classification rule and a master application in the group. Application types of applications corresponding to the specified shortcuts are the same as a application type of the master application in the group. When a number of the specified shortcuts is greater than the number of M, the classification module 101 calculates a usage frequency of each of the applications corresponding to the specified shortcuts in a second preset duration. The classification module 101 arranges the usage frequency of each of the applications corresponding to the specified shortcuts in a descending order and generates a sorting result. The classification module 101 selects a number of “(M−1)” usage frequencies from the sorting result according to the descending order, and determines a number of “(M−1)” shortcuts corresponding to the selected usage frequencies. The classification module 101 classifies the number of “(M−1)” shortcuts into the group, thus, the group has M shortcuts including the master shortcut and the “(M−1)” shortcuts. The “(M−1)” shortcuts are non-master shortcuts in the group.

In other embodiments, the second requirement of the classification rule requires that shortcuts in each of the groups are determined according to invoking times of an application corresponding to each of the shortcuts in each of the groups. For example, in one group, a preset number of the shortcuts in the group is N. The classification module 101 calculates invoking times of each of the shortcuts on the desktop that is invoked by a master application of the group within the first preset duration. When a number of the shortcuts on the desktop is greater than the preset number of N, the classification module 101 arranges the invoking times of each of the shortcuts on the desktop that is invoked by the master application in a descending order and generates a sorting result. The classification module 101 selects a number of “(N−1)” invoking times from the sorting result, and determines a number of “(N−1)” shortcuts corresponding to the number of “(N−1)” invoking times. The classification module 101 classifies the number of “(N−1)” shortcuts into the group, thus, the group has N shortcuts including the master shortcut and the “(N−1)” shortcuts. The “(N−1)” shortcuts are non-master shortcuts in the group.

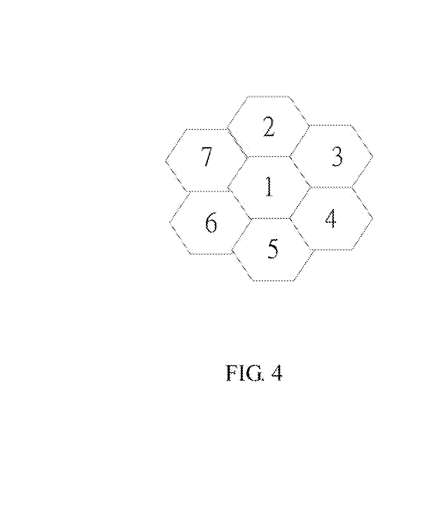

The displaying module 102 displays each of the groups using a graphics on the display device. In at least one embodiment, the graphics corresponding to each of the groups is a honeycomb pattern. As shown in FIG. 4, a number “1” represents a master shortcut in the group, numbers “2”, “3”, “4”, “5”, “6”, “7” represent other shortcuts in the group.

In at least one embodiment, the user can select a group and selects an adjustment option for the selected group. The adjustment module 103 resets a classification rule and a master shortcut in the selected group by executing the adjustment option. According to the reset classification rule and the reset master shortcut in the selected group, shortcuts in the selected group can be adjusted by using the setting module 100, the classification module 101 and the displaying module 102. In other embodiments, the adjustment module 103 can be invoked by the user to re-classify the shortcuts in the groups manually.

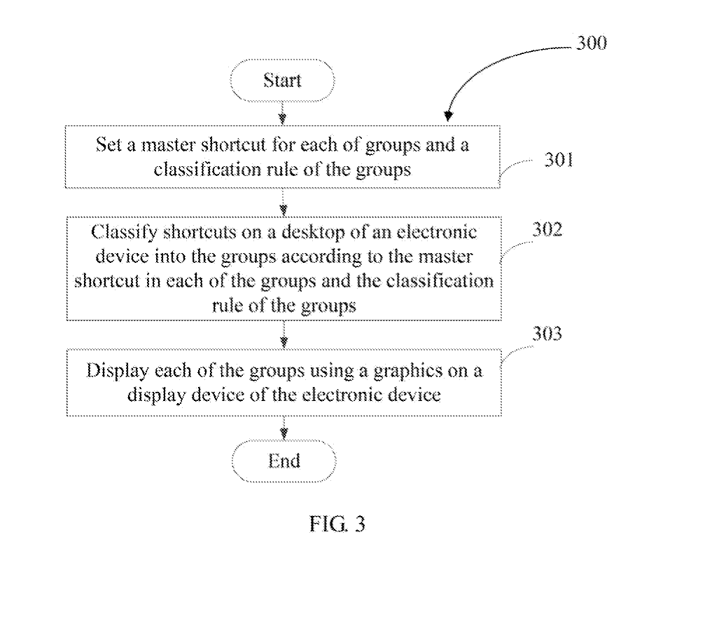

FIG. 3 illustrates a flowchart is presented in accordance with an example embodiment. The example method 300 is provided by way of example, as there are a variety of ways to carry out the method. The method 300 described below can be carried out using the configurations illustrated in FIGS. 1 and 2 for example, and various elements of these figures are referenced in explaining example method 300. Each block shown in FIG. 3 represents one or more processes, methods, or subroutines carried out in the exemplary method 300. Furthermore, the illustrated order of blocks is by example only and the order of the blocks can be changed. The exemplary method 300 can begin at block 301. Depending on the embodiment, additional steps can be added, others removed, and the ordering of the steps can be changed.

At block 301, a setting module sets a plurality of groups, sets a master shortcut for each of the groups and a classification rule of the groups. In at least one embodiment, the setting module provides a user interface (UI) on a display device of the electronic device for the user to select the master shortcut for each of the groups and set the classification rule of the groups. According to selections and settings of the user, the setting module sets the master shortcut for each of the groups and the classification rule of the groups. The setting module can further provide an option of selecting or setting a number of the groups and an option of selecting or setting a number of shortcuts in each of the groups on the user interface for the user.

In at least one embodiment, each of the shortcuts in each of the groups corresponds to an application, and the master shortcut in each of the groups corresponds to a master application. The classification rule represents a relationship between the master shortcut in each of the groups and other shortcuts in each of the groups. The classification rule includes two requirements. A first requirement requires that applications corresponding to other shortcuts in each of the groups are in a same application type with the master application in each of the groups, and a second requirement requires that shortcuts in each of the groups are determined according to invoking times of an application corresponding to each of the shortcuts in each of the groups. The invoking times represents times that an application is invoked by a master application of a group that the application belongs to within a first preset duration. In some embodiments, one of the two requirements of the classification rule is required while classifying the shortcuts on the desktops. In other embodiments, both of the two requirements of the classification rule are required while classifying the shortcuts on the desktops.

At block 302, a classification module classifies the shortcuts on the desktop of the electronic device into the groups according to the master shortcut of each of the groups and the classification rule of the groups. Each of the groups includes a master shortcut in each of the groups and non-master shortcuts in each of the groups. The non-master shortcuts in each of the groups represent shortcuts in each of the groups except the master shortcut in each of the groups. The classification module can classify one shortcut on the desktop into one or more groups. The classification module can classify one master shortcut into another group according to a master shortcut of the another group and the classification rule. In other words, a master shortcut of a group can be a non-master shortcut in another group.

In at least one embodiment, for each of the groups, the classification rule of the groups requires that the other applications corresponding to the other shortcuts in each of the groups are in a same application type as the master application of each of the groups. For example, in one group, a preset number of shortcuts in the group is M. The classification module determines specified shortcuts from the shortcuts on the desktop according to the classification rule and a master application in the group. Application types of applications corresponding to the specified shortcuts are the same as a application type of the master application in the group. When a number of the specified shortcuts is greater than the number of M, the classification module calculates a usage frequency of each of the applications corresponding to the specified shortcuts in a second preset duration. The classification module arranges the usage frequency of each of the applications corresponding to the specified shortcuts in a descending order and generates a sorting result. The classification module selects a number of “(M−1)” usage frequencies from the sorting result according to the descending order, and determines a number of “(M−1)” shortcuts corresponding to the selected usage frequencies. The classification module classifies the number of “(M−1)” shortcuts into the group, thus, the group has M shortcuts including the master shortcut and the “(M−1)” shortcuts. The “(M−1)” shortcuts are non-master shortcuts in the group.

In other embodiments, the second requirement of the classification rule requires that shortcuts in each of the groups are determined according to invoking times of an application corresponding to each of the shortcuts in each of the groups. For example, in one group, a preset number of the shortcuts in the group is N. The classification module calculates invoking times of each of the shortcuts on the desktop that is invoked by a master application of the group within the first preset duration. When a number of the shortcuts on the desktop is greater than the preset number of N, the classification module arranges the invoking times of each of the shortcuts on the desktop that is invoked by the master application in a descending order and generates a sorting result. The classification module selects a number of “(N−1)” invoking times from the sorting result, and determines a number of “(N−1)” shortcuts corresponding to the number of “(N−1)” invoking times. The classification module classifies the number of “(N−1)” shortcuts into the group, thus, the group has N shortcuts including the master shortcut and the “(N−1)” shortcuts. The “(N−1)” shortcuts are non-master shortcuts in the group.

At block 303, a displaying module displays each of the groups using a graphics on the display device. In at least one embodiment, the graphics corresponding to each of the groups is a honeycomb pattern.

In at least one embodiment, the user can select a group and selects an adjustment option for the selected group. A adjustment module resets a classification rule and a master shortcut in the selected group by executing the adjustment option. According to the reset classification rule and the reset master shortcut in the selected group, shortcuts in the selected group can be adjusted by using the setting module, the classification module and the displaying module. In other embodiments, the adjustment module can be invoked by the user to re-classify the shortcuts in the groups manually.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for managing desktop shortcuts of an electronic device being executed by a processor of the electronic device, the method comprising:
setting a master shortcut for each of groups and a classification rule of the groups;
classifying shortcuts on a desktop of the electronic device into the groups according to the master shortcut in each of the groups and the classification rule of the groups; and
displaying each of the groups using a graphics on a display device of the electronic device.

2. The method according to claim 1, wherein each of the shortcuts in each of the groups corresponds to an application, and the master shortcut in each of the groups corresponds to a master application.

3. The method according to claim 2, wherein the classification rule requires that applications corresponding to other shortcuts in each of the groups are in a same application type with the master application in each of the groups.

4. The method according to claim 2, wherein the classification rule requires that shortcuts in each of the groups are determined according to invoking times of an application corresponding to each of the shortcuts in each of the groups, the invoking times represents times that an application is invoked by a master application of a group that the application belongs to within a first preset duration.

5. The method according to claim 1, wherein the graphics corresponding to each of the groups is a honeycomb pattern.

6. The method according to claim 1, further comprising:
re-setting a classification rule and a master shortcut in a selected group when an adjustment option is executed on the selected group; and
adjusting shortcuts in the selected group according to the reset classification rule and the reset master shortcut in the selected group.

7. An electronic device, comprising:
a processor; and
a storage device that stores one or more programs, when executed by the at least one processor, cause the at least one processor to:
set a master shortcut for each of groups and a classification rule of the groups;
classify shortcuts on a desktop of the electronic device into the groups according to the master shortcut in each of the groups and the classification rule of the groups;
display each of the groups using a graphics on a display device of the electronic device;
control the electronic device to acquire the information of the current user according to the control command, and storing the acquired information; and
transmit the acquired information to the server.

8. The electronic device according to claim 7, wherein each of the shortcuts in each of the groups corresponds to an application, and the master shortcut in each of the groups corresponds to a master application.

9. The electronic device according to claim 8, wherein the classification rule requires that applications corresponding to other shortcuts in each of the groups are in a same application type with the master application in each of the groups.

10. The electronic device according to claim 8, wherein the classification rule requires that shortcuts in each of the groups are determined according to invoking times of an application corresponding to each of the shortcuts in each of the groups, the invoking times represents times that an application is invoked by a master application of a group that the application belongs to within a first preset duration.

11. The electronic device according to claim 7, wherein the graphics corresponding to each of the groups is a honeycomb pattern.

12. The electronic device according to claim 7, wherein the at least one processor is caused to:
re-set a classification rule and a master shortcut in a selected group when an adjustment option is executed on the selected group; and
adjust shortcuts in the selected group according to the reset classification rule and the reset master shortcut in the selected group.

13. A non-transitory storage medium having stored thereon instructions that, when executed by a processor of an electronic device, causes the processor to perform a management method, wherein the method comprises:
setting a master shortcut for each of groups and a classification rule of the groups;
classifying shortcuts on a desktop of the electronic device into the groups according to the master shortcut in each of the groups and the classification rule of the groups; and
displaying each of the groups using a graphics on a display device of the electronic device.

14. The non-transitory storage medium according to claim 13, wherein each of the shortcuts in each of the groups corresponds to an application, and the master shortcut in each of the groups corresponds to a master application.

15. The non-transitory storage medium according to claim 14, wherein the classification rule requires that applications corresponding to other shortcuts in each of the groups are in a same application type with the master application in each of the groups.

16. The non-transitory storage medium according to claim 14, wherein the classification rule requires that shortcuts in each of the groups are determined according to invoking times of an application corresponding to each of the shortcuts in each of the groups, the invoking times represents times that an application is invoked by a master application of a group that the application belongs to within a first preset duration.

17. The non-transitory storage medium according to claim 13, wherein the graphics corresponding to each of the groups is a honeycomb pattern.

18. The non-transitory storage medium according to claim 13, wherein the method comprises:
re-setting a classification rule and a master shortcut in a selected group when an adjustment option is executed on the selected group; and
adjusting shortcuts in the selected group according to the reset classification rule and the reset master shortcut in the selected group.
